(19) United States
(12) Patent Application Publication
(10) Pub. No.: US 2009/0055227 A1
(43) Pub. Date: Feb. 26, 2009

(54) Risk Assessment Company

(76) Inventor: Thomas L. Bakos, Ridgway, CO (US)

Correspondence Address: Markets, Patents & Alliances LLC, 30 Glen Terrace, Stamford, CT, 06906-1401, US

(21) Appl. No.: 12/261,081

(22) Filed: Oct. 30, 2008

(51) Int. Cl. G06Q 40/00

(52) U.S. Cl. 705/4

(57) ABSTRACT

A Risk Assessment Company (RAC) maintains an up to date Risk Profile Data Base (RPDB) on its members based on their normal periodic health checkups. The Risk Assessment Company, therefore, can offer life or health insurance policies from a plurality of carriers to any given member at any given time based on the underwriting class determined by the data in the Risk Profile Data Base. The Risk Assessment Company can also provide a member with a life or health expectancy report containing suggestions on how said person can improve his or her life or health expectancy.

### FIELD OF INVENTION

This invention unbundles the risk evaluation and selection (i.e. underwriting) function of the insurance sales process and establishes it as a separate, independent, stand alone process. It provides for the “pre-underwriting” of individuals for insurance thus allowing binding offers to be made by many insurance companies all utilizing the same underwriting data. It will promote a more competitive insurance market. It will allow for a more cost effective way to underwrite and offer insurance. The cost reductions will allow for the provision of premium discounts. In addition, life, health, or other risk evaluation services will be provided to subscriber members even in the absence of any insurance application. The risk evaluation services will be useful to subscribers to improve or reduce the risks they are exposed to. A reduced insurance risk will result in additional premium discounts while the risk reduction effects are in place.

### Peer-to-Patent

This application was specifically drafted for Peer-to-Patent review. We expect that actuaries and other knowledgeable persons in the life and health insurance industry will be the primary peer reviewers and so we have drafted this application, including the claims, with that in mind.

We thank you in advance for your constructive input.

### BACKGROUND

The marketing and sale of life and health insurance involves an underwriting function in which the exposure of the insurance applicant to the risk being insured is evaluated and measured in order to determine insurability and set an appropriate premium for the insurance coverage applied for. This underwriting process has several problems:
Applicants do not know if they have insurance coverage or what it will cost until the insurer underwriting process is complete.
Insurers incur an expense for underwriting. This expense is passed on and included in the premiums paid by the applicants who actually buy insurance. That is, insurers must recover their underwriting expenses with respect to applicants who do not purchase insurance from those that do which results in higher premiums.
Applicants who shop for insurance coverage apply to more than one insurer and, therefore, must undergo multiple, redundant underwriting processes. This is inconvenient to the applicant and increases the total industry-wide cost of acquiring insurance coverage associated with the applicant.
Applicants, generally, do not have a complete understanding their health status and, so, may be surprised by the insurer's underwriting result and insurance offer if it is not in the best or near best underwriting class.
Insurer underwriting introduces long delays into the insurance marketing and sales process.

If an insurance company were able to more effectively determine insurability by reliance on a completed independent risk assessment then insurance could be offered at guaranteed insurance premiums and at lower cost and, if accepted by the applicant, could be issued immediately.

In addition, applicants could indicate the insurance they were interested in purchasing in an Internet insurance shopping center, allow access to their risk assessment data, and receive immediate or near immediate insurance quotes from a large number of interested insurance companies.

Additional benefits could be provided to members who participate in a risk assessment process as described herein. Members participating in a risk assessment process would have access to life and health expectancy statistics based on their stored personal health data which they could use to measure the effect of life style changes they might adopt to improve their life or health status. Said personal health data could be a single automated data base upon which members could rely in order that medical care providers or emergency health care workers would have immediate access to current medical data in order to provide better, less expensive emergency or regular care.

Another benefit of a member's participation in a risk assessment data base and receiving periodic reports on life and health expectancy is that members would have incentive, resources, and useful feedback which would allow them to better manage their own health care which would result in improved life and health expectancy. Said improved life and health expectancy through participation in the risk assessment program would encourage and allow participating insurance companies to provide premium discounts to reflect the expense, mortality, and health savings they would experience as a result of said member's participation.

### SUMMARY OF THE INVENTION

The Summary of the Invention is provided as a guide to understanding the invention. It does not necessarily describe the most generic embodiment of the invention or all species of the invention disclosed herein.

A Risk Assessment Company (RAC) builds and maintains a Risk Profile Data Base (RPDB) with respect to individual lives who subscribe to its service. The RPDB is contained and accessed in a highly secure electronic environment, such as a HIPPA compliant system.

The RPDB is a principal asset of an RAC. In order to build and maintain the RPDB and provide services to its customers and clients, the RAC will design and develop technologies consistent with existing, successful technologies and expertise in related businesses.

Subscribers to the services provided by an RAC comprise individuals who would benefit from (for example):
A constant storage location for accurate and complete medical records regardless of doctor, job, residence, or insurance changes;
Immediate emergency access to medical records when traveling away from home;
Personalized medical reports with a full, written explanation of all test results;
A life and health expectancy analyses summarizing the risks associated with medical or lifestyle decisions; and
Access to an on-line medical library.

These benefits of membership in an RAC are designed to encourage individuals to subscribe to the services the RAC provides. Individual subscribers may be asked to pay a fee for full membership benefits.

Subscribers to the services provided by an RAC would also comprise companies or entities which function as contributors to, or users of, health or life expectancy information with respect to individuals or groups of individuals. For example, entities providing health related services publicly or privately in areas such as:
insurers/reinsures underwriting functions;
health care providers;
labs;
pharmacies;
paramedical facilities;
medical records data base technologies;
medical information libraries; and
Internet service providers,
   would receive value from subscribing to RAC provided services.

An RAC will provide a way for companies or entities involved in health related industries to make better use of their processes and knowledge. The resulting expansion of markets and elimination of expense redundancies will drive the development of an efficient and profitable company providing necessary and useful services.

For example, the use of an unbundled risk assessment approach will significantly change the way life insurance is marketed. An individual RAC subscriber's risk class could be quickly and easily derived by reference to the subscriber's risk profile contained in the RPDB. As a result, an actual premium could be illustrated and an insurance policy could be issued almost immediately. Access to the RAC database could be made at the time an insurance application is made in order to determine insurability, or the RAC data base could be used to pre-determine insurance eligibility and make binding insurance offers to RAC subscribers.

An individual RAC subscriber, because of the perceived value of membership in the RAC, would be willing to incur a reasonable cost necessary to create and maintain a risk profile in the RPDB. This would be so, in part, because the subscriber's costs would be kept low by building the development of the RAC on the elimination of redundancies and their expenses in services already provided and paid for by the subscriber. Fees paid by company and business entity subscribers to the RAC services may also be used to reduce or eliminate subscriber fees for individual participants.

The changes to the insurance industry could be enormous. For example:
For the first time, the Internet (or any other direct marketing channel) could be used to offer competitively priced, fully underwritten life insurance.
Agent or broker assisted life insurance sales would be simplified by eliminating the frustrating underwriting delay (6-8 weeks) which typically interferes with closing a sale.
RAC assisted life insurance sales would put life insurance products on an equal marketing footing with other financial products such as bank accounts, CD purchases, and securities purchase or trading, thus opening up new marketing possibilities.

The economies of the sales process introduced by the RAC application of unbundled risk assessment would create a competitive pricing advantage for insurance companies using RAC services. These advantages are created by the following:
Insurers would not incur all of the risk assessment costs directly. Some would be paid or offset upfront by the applicant through the applicant's membership participation in the RAC.
Insurers would incur little or no underwriting acquisition costs with respect to Not Taken policies.
Underwriters in life insurance companies would be more efficient because of greater reliance on expert systems, no waiting for requirements, and less contact with the insurance agent.
Marketing and distribution would be simplified.

An RAC process creates a common health data base, a Risk Profile Data Base (RPDB), that is maintained independent of any specific use and can be reliably used as a source of life and health expectancy data by the individual subscribers and by company and business entity subscribers who rely on such information for the proper and efficient conduct of their business activity.

The RAC model may also be applied to other types of risk. For example, as individual credit risk is currently assessed by a number of companies by reference to credit risk data bases, other types of risk to which individuals are exposed and which are not currently effectively addressed, may also be incorporated into the risk assessment services provided by an RAC. Examples of these other types of risk include but are not limited to: casualty risk (flood, geological, weather, accident, travel, etc.), personal economic risk (home purchase, personal investment, etc.), enterprise risk (business failure, product quality, etc.), or any other risk that may financially impact personal life style or business relationships. The RAC could, as a service to its subscribers, evaluate and assess these other types of risks and provide evaluations in terms of probabilities of failure or success. For example, a subscriber intending to purchase a home could receive a financial risk evaluation relative to the likelihood the subscriber would be able to avoid default on a mortgage and foreclosure taking into account the terms of the mortgage and likely economic scenarios.

The RPDB would be tested and verified using internal consistency checks and by reviews by subscribers of their individually stored data. Insurers would be allowed to audit the underwriting conclusions reached by application of RAC underwriting processes applied to the RPDP. These audits, for example, may be facilitated by insurer-provided test records where an insurer could compare an RAC underwriting evaluation to the insurer's own underwriting evaluation. The RAC underwriting process may allow for variations applied relative to each participating insurance company or other company relying on a risk evaluation from the RAC.

### BRIEF DESCRIPTION OF FIGURES

FIG. 1 is a table of sample life underwriting requirements.

FIG. 2 is a table of marginal underwriting acquisition expense.

FIG. 3 is a table of expense assumptions for a 10 year term policy.

FIG. 4 is a table of estimated marginal underwriting expenses.

FIG. 5 is a table of estimated allocated underwriting expenses.

FIG. 6 is a table of estimated RAC expense savings for a 10 year term policy.

FIG. 7 is a table of expense assumptions for a whole life policy.

FIG. 8 is a table of a whole life policy example.

### DETAILED DESCRIPTION

Persons of ordinary skill in the art will recognize that the following disclosure is illustrative only and not in any way limiting. Other embodiments of the disclosure will readily suggest themselves to such skilled persons having the benefit of this disclosure.

The economic, or financial, premise for a Risk Assessment Company (RAC) is the elimination of the redundancies typically found in the mechanisms of the healthcare and insurance services currently provided to individual consumers. The elimination of these redundancies will reduce expenses for each of the service providers and benefit consumers by providing better services at lower cost.

The expense reduction would be possible by combining the similar functions performed by each service provider. The basic elements of the similar functions would be modified (if necessary) to accommodate the specific need of each company. Each company would then piggyback its service on this common function which would only need to be performed once with its benefits shared multiple times.

The service providers that could benefit from this reorganized approach include the following:

### Health Care Providers and Facilities

Doctors' offices and hospitals are providing medical evaluation and treatment on a more impersonal basis than in the past. Fewer people today can claim to have a physician personally involved in their health care. Mobility in our society with respect to job, home, and health insurance provider has contributed to this change in the way health care is provided.

In addition, the incentive to reduce the costs of providing medical care has required physicians to see more patients and spend less time with each one. The concern for claims of medical malpractice has required doctors to structure treatments designed to forestall such claims. Because of this, health care costs are rising and patients have less access to affordable medical ca re.

Medical advances have made medical care more complicated and what is known about it more detailed. At the same time, doctors and other care givers have little time to offer the necessary explanations for the advice and treatment they give or the raw information they have acquired through medical testing.

Many people want to have a more active role in their health care and a better understanding of their physical condition and what they can do to keep themselves healthy. It is difficult and expensive for these people to rely on their health care provider for wellness health care or advice.

### Administrative and Record Keeping Companies

Over 25 established companies provide doctors' offices with electronic medical records (EMR), or data base systems. The focus of these companies is to improve doctor efficiency and communication with patients. Some of these companies allow the physician gathered information and findings stored in the EMR to be directly accessible by patients over the Internet. These systems also allow for improved efficiency by creating links to practice management software, laboratories, transcription services, and hospital information systems.

There are also established companies (e.g. the Medical Information Bureau or MIB) providing medical related and other information required by insurance companies to establish a risk profile for an insurance applicant.

Some companies in this grouping also provide consumer-focused medical and healthcare information directly to individual subscribers via the Internet. Often these sites allow consumers to build their own personal health profiles to allow them to keep track of important medical data. These sites address the need to help people play an active role in managing their own health care.

### Insurance and Reinsurance Companies

The purpose of life and health insurance is to help individual consumers finance, or manage, the costs associated with their life and health risk uncertainties. In effect, insurance companies function as an instrument through which individuals can pool the risks to which they are exposed with other similarly situated individuals. Fairness, equity, and law (through unfair discrimination statutes) require that like risks be grouped together. Therefore, in any voluntary insurance program, underwriting, or risk selection, is a necessity.

Reinsurance companies are playing an increasingly larger role in risk selection and are absorbing a much larger share of the underwriting risk while direct writing companies are focusing more on the manufacture and distribution of products. Publicly held insurance company management may shun risk assumption because of the statistical fluctuation in earnings it can create, particularly for relatively small companies. These insurers may focus more on asset management, wealth enhancement, and estate and financial planning. Increasingly, new insurance company management has come from the banking and securities industries and these new people have brought those risk averse traditions with them.

Reinsurers have a larger experience base, better analysis tools, and greater expertise in assessing risk. They are, therefore, more comfortable absorbing underwriting risk at rates direct writers would not touch. As a consequence, reinsurers are getting a bigger share of the insurance risk market.

### How an RAC Would Operate

A Risk Assessment Company could be effectively used to provide services to individuals or companies and business entities which are affected by any sort of risk.

The RAC would ideally be a national company having established relationships with health care providers and paramedical facilities. Through these relationships, the medical data specifically needed for life insurance underwriting would be acquired.

An RAC-negotiated fee structure with these health care providers should be able to take advantage of the fact that the RAC's clients are also participants in health care plans that rely on these health care providers for service. By making multiple use of medical data and eliminating redundant testing, an expense savings will be realized.

For example, HMO or PPO coverage provided through a group health plan typically allows a periodic, routine physical exam for, say, a $15-$25 co-pay or encounter fee. These plans also cover the cost of lab tests or other tests considered necessary by the examining physician. As an add-on to this periodic health evaluation, an individual could be offered, or request, what might be called the insurance or mortality risk assessment supplement.

This supplement would direct that medical tests or analysis which are required for insurance underwriting but are not normally part of a routine medical exam be performed. For example, a blood draw might have a fee associated with it. There are a variety of different sets of laboratory tests that can be done on that blood sample each with an additional separate fee. Each said blood test has a specific objective, for example: various sorts of blood counts; allergy testing; tests for auto immune diseases; cancer detection; determining cholesterol levels; diabetes testing; hormone levels; testing for infectious diseases; organ function; etc. By associating multiple purposes to a single blood draw redundant blood draws can be avoided and overall fees reduced. A small additional fee, which individual would pay along with the co-pay, may be charged for this supplement. An additional option may be that the amount of supplemental information collected and the fee could be dependent on a level selected by the individual which would be based on how much life or health insurance or other type of insurance he or she anticipated needing.

Within the RAC, underwriters or risk selection evaluation experts, aided perhaps by electronic expert underwriting systems will evaluate the medical information provided by the RAC's health care partners. The RAC will gather the non-medical data essential for a life insurance risk evaluation using authorizations provided by the client on the form completed to request the services of the RAC. Said non-medical data may include, for example, financial information, employment information, information on avocations, travel, or family history that may affect mortality, morbidity, or other risk. Using all of this information, the RAC will create a risk assessment profile for the individual (a Risk Profile Data Base or RPDB), coded per a standardized process and maintained in a secure electronic data-base.

The use of an independent underwriting risk assessment company will facilitate the sale of fully underwritten life insurance in the e-commerce marketing environment by making the risk profile information provided reliable. It will do this economically by piggybacking on periodic medical exams that ought to be part of every individual's health care program, whether or not they are considering the purchase of life insurance.

This e-commerce restructuring of the life insurance sales process will also introduce expense efficiencies, which will give life insurers that utilize the process a competitive advantage over life insurers that don't.

### Advantages of the RAC Approach

### Insurance Company Advantages

A Risk Assessment Company would allow an insurer to unbundle the risk evaluation and selection (underwriting) process from the insurance sales process. The RAC would provide an independent risk assessment on individual lives for a fee. This risk assessment would be done either before or early in the sales process. It could be used by any insurance company to provide binding insurance illustrations or quotes to individual RAC subscribers who apply for insurance. An applicant would merely need to accept the offer in order to put insurance immediately and unconditionally into effect on his or her life.

Insurers using the RAC would realize significant expense savings that they could reflect as lower premiums. Expense savings would result from several sources:
Insurers would not incur risk assessment or underwriting costs directly. In effect, the insurer underwriting function would be outsourced to an RAC.
Insurers would incur no selection costs with respect to Not Taken policies.
Marketing and distribution would be simplified and made more efficient.

Individuals who had decided or been advised that life insurance should be a part of their financial program would be encouraged to utilize the services of an RAC and pay any required service fees because of the significant insurance cost advantage of the RAC issued policy. Applicants could receive an almost immediate payback of their upfront RAC subscriber charges, if any, through first year premium savings provided by insurers offering insurance products discounted because of issue through the RAC process.

The traditional cost of the medical portion of the risk assessment process would be further reduced by piggybacking it onto the periodic medical/physical exams which are typically provided for a small encounter fee or co-pay as part of most insured health care plans (HMOs, PPOs, etc.).

In addition to the fact that the RAC risk profile assessment would provide life insurers with the ability to issue fully underwritten, lower priced life insurance products immediately, other advantages exist:
Insurance carriers could distance themselves from the selection activity making their underwriting staff more efficient.
In an RAC environment, life insurance would be on an equal marketing footing with all other financial products.
The use of the Internet in the sale of life insurance would be enabled. This would encourage paperless, signature-less contracts and additional economies in distribution.

A life insurer not using an RAC could find itself in a very uncompetitive position.

### Individual Subscriber Advantages

RAC services would be designed to have a standalone value making them additionally desirable to many consumers, even those not currently contemplating the purchase of life insurance.

For example, an RAC could utilize the medical and non-medical risk assessment data it collected in order to provide the consumer with an individualized risk assessment report. Initially, the report would evaluate life and health risk by providing life and health expectancies and access to a personalized medical information data base relevant to the individual subscriber's risk profile. This could be used by subscribers to understand and manage their current health.

### Security Issues

An individual's use of an independent RAC could be an effective way to address his or her privacy concerns. The subscriber to the RAC service would clearly establish ownership of his or her own medical/underwriting information by paying for it. Access to a subscriber's risk profile on the RPDB would only be available with proper authorization from the subscriber.

In addition, those companies that intended to rely on the RPDB would need assurances that it was constructed in an impartial and untainted way. Providing this security to subscriber members and company users of the RAC services would be a primary function of the Risk Assessment Company.

### Subscriber Costs Offset

Any subscriber fee that might be charged to an individual to use the risk assessment company process could be reimbursed in a number of ways. For example, an insurance company could pay an applicant for access to the applicant's risk assessment profile. The applicant could provide access through release to the insurance company of a verifiable code and authorization to use it. The individual could either receive insurance coverage at a lower rate, reflecting the insurer's cost savings, or the issuing company could provide another form of premium credit with respect to coverage they actually issue.

Periodic physical exams are a normal part of a health care program. An individual could keep his risk profile current through a periodic update in connection with periodic physicals. By doing so, an individual would always remain eligible for the almost immediate issue of a fully underwritten life insurance policy through an e-commerce or any other channel of distribution. An insurer may provide an annual premium discount to an insured who kept his risk profile status current. The fact that the risk profile is kept current indicates a pro-active involvement in health maintenance, resulting in a likely positive impact on mortality of the class. Adverse changes in any specific individual's risk profile would not be expected to offset overall improved class mortality and could be ignored.

### Other Benefits

The risk assessment company could also provide an individualized health evaluation to its clients based on the data it collected. This would consist of an unbiased evaluation of the mortality class to which the client belonged, along with comparative data to help the client evaluate any deviation, positive or negative, from standard.

Detailed test results could be provided with explanations of what the raw numbers mean, and how they interrelate. In a written report or through a secure Web site, the RAC could provide suggestions for possible changes in life style, habits, diet, activity, or medications that could have an impact on the risk evaluation. Therefore, even if the data were not used to purchase life insurance, it would be of value to a client interested in better managing his or her health.

### Possible Future Benefits

Long term, the analysis could be expanded into the financial and credit areas. Its reports could place dollar values on the relative probabilities of events an individual is exposed to. These reports and analyses would allow the consumer to make educated decisions with respect to life style or insurance/self-insurance choices with respect to (for example) life, health, auto, homeowners, and credit/debt issues. More broadly, risks included in the RAC process might include but are not limited to: casualty risk (flood, geological, weather, accident, travel, etc.), personal economic risk (home purchase, personal investment, etc.), enterprise risk (business failure, product quality, etc.), or any other risk that may financially impact personal life style or business relationships.

As medical technology develops, additional services could be added as they became economic to provide. For example, consumer genome analysis could be matched against known drug-genome interactions. It is becoming evident that, in order for some prescription medication to be effective in any individual, a gene enabled process must exist in order for the body to properly breakdown and use the drug. The RAC could alert its consumers to personally ineffective or potentially dangerous drug interactions. A customer may be allowed to restrict his or her own access to personal genome data so that the RAC would report only on controllable outputs. The consumer could choose to remain uninformed with respect to conditions for which there is no known treatment or avoidance mechanism. Therefore, consumer use of this data for adverse selection could be avoided without impacting access to genetic information useful in potentially successful treatments.

### Additional Consumer Value in Data

Ancillary uses for the data collected could also be developed by the RAC. For example, a current risk profile might satisfy the pre-employment medical exam needs of many companies, eliminating an awkward human resources requirement.

With the permission of the individual, the data could be used anonymously in studies useful to the insurance or medical communities or to the government health agencies. To the extent that these ancillary uses generated revenue, the individual cost of participating in a risk assessment program would be reduced.

### A Life Underwriting Example

This analysis of the application of the RAC process is focused on the middle issue age ranges (18-65) and moderate insurance application face amounts (under $2,000,000). Experience with the process will allow extension of the eligible age range and face amounts applied for in excess of $2 million. It is expected, that special circumstances (e.g. very large face amounts or unusual risks) may require exceptions to a clean use of unbundled risk assessment.

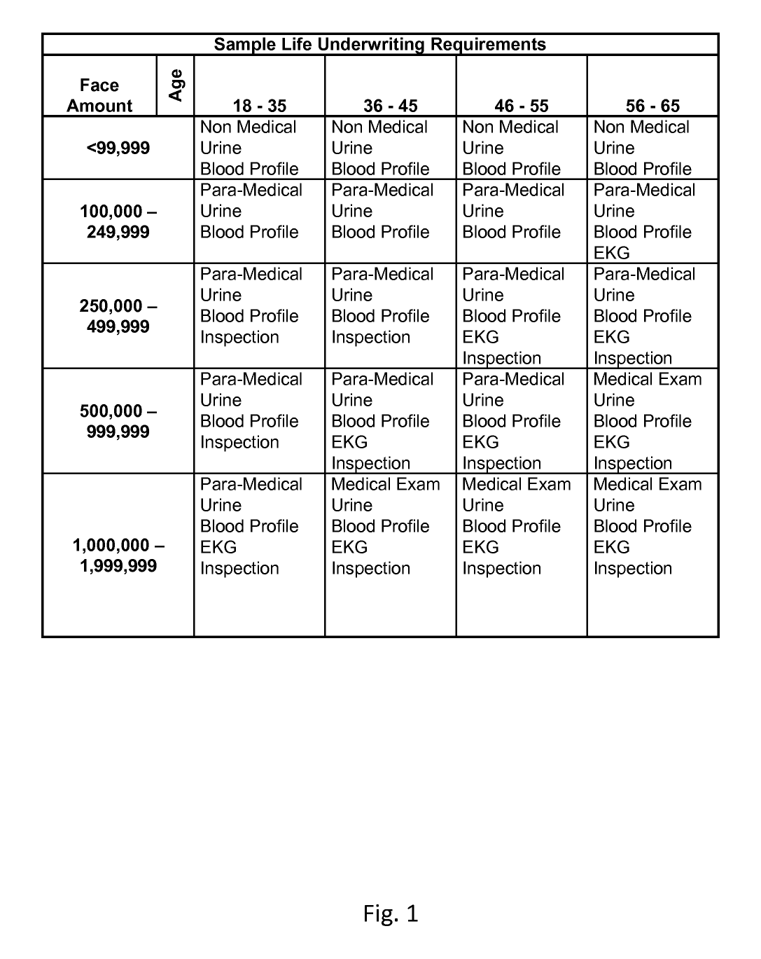

FIG. 1 provides a typical set of underwriting limits and requirements for the initial age range and face amounts contemplated.

Different companies may indicate different breaks and splits for additional requirements, but the above table is representative of the general industry requirements and is a reasonable reference for determining pricing cost savings that would be provided by the RAC risk assessment process.

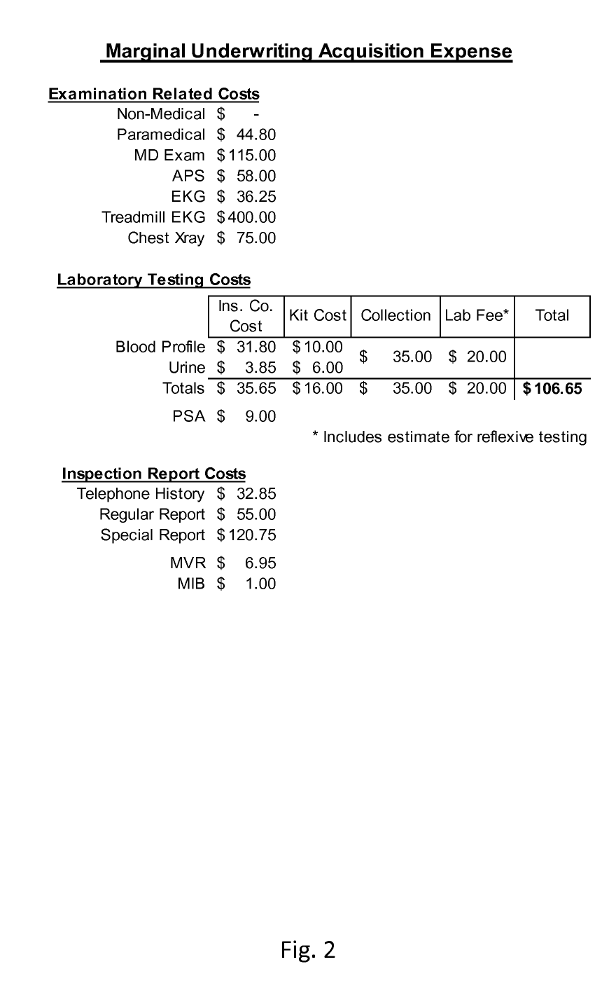

FIG. 2 indicates typical expenses associated with the medical examinations and reports indicated in the underwriting limits and requirements table.

Marginal underwriting acquisition expenses are intended to identify the expenses paid to outside providers for information used by a life insurance company to underwrite a life insurance applicant. These are the expenses incurred for each applicant underwritten whether or not a policy is actually issued. Therefore, when these expenses are factored into pricing calculations they are grossed up to cover the cost of underwriting Not Taken policies.

In addition to these marginal expenses, a life insurer will incur in house underwriting, policy issue, and administrative expenses which will be combined with the marginal expenses and allocated in an expense study to calculate per policy, per thousand, and percent of premium expense pricing assumptions.

### Estimate of RAC Savings

A reasonable estimate of the average expenses to issue and maintain a life insurance policy is shown in the table below.

### Year Term Example

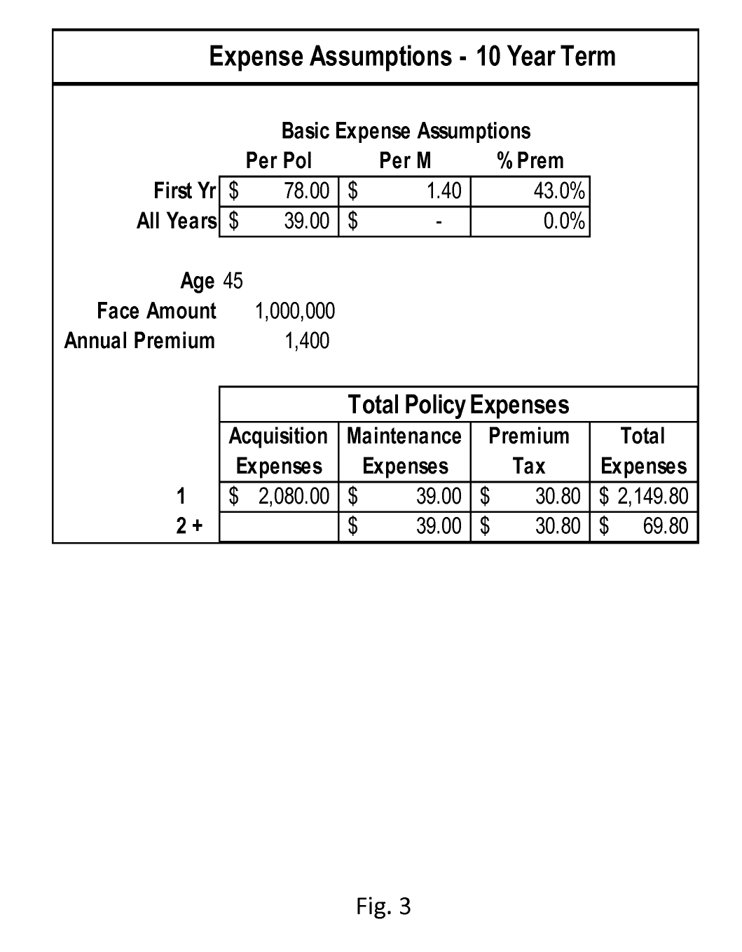

FIG. 3 shows unit expense assumptions applied to a hypothetical $1,000,000 Ten Year Term level premium policy issued to a Male Age 45. It is assumed the policy is issued in a company's very best underwriting class. By way of example, such a policy might have an annual premium of about $1.40/M or $1,400 in total. Premium taxes are assumed to be 2.2% of premium to calculate the total expenses shown.

Therefore, the total acquisition expenses for this 10 Year Term policy as shown in column 1 of the table above are $2,080.

By using a Risk Assessment Company, a life insurer would not directly incur the marginal underwriting expenses required to provide the Medical Exam, blood profile, home office specimen (urine), EKG, PSA, APS, Inspection Report, Motor Vehicle Record search, and the MIB check required by the company's underwriting requirements.

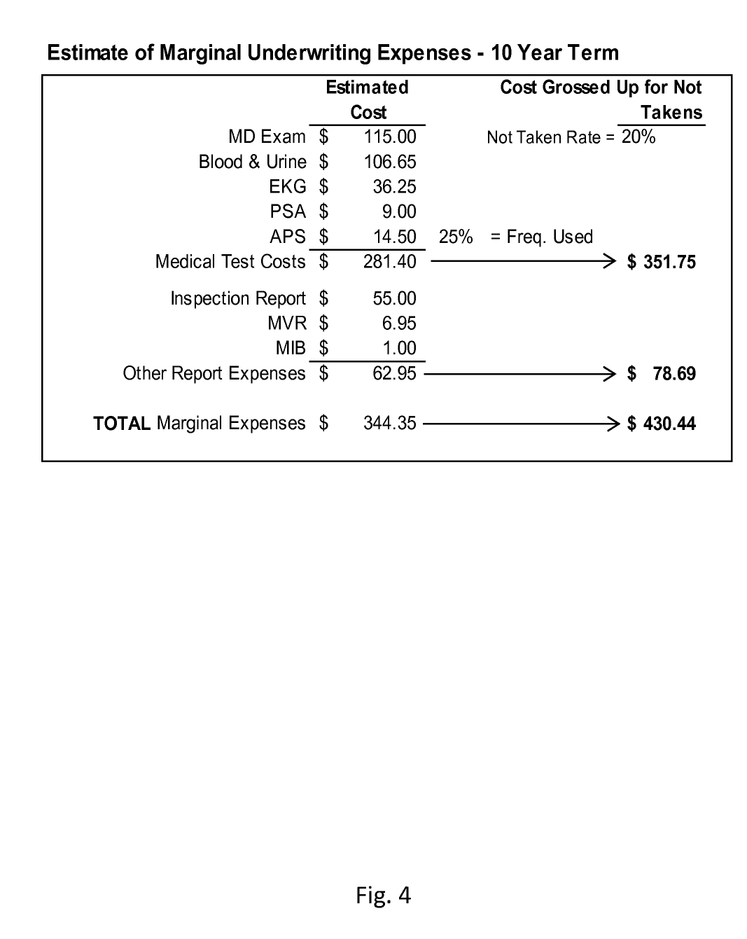

FIG. 4 itemizes the expenses for these examinations and reports that the insurer would avoid.

A Not Taken rate of 20% is assumed. Therefore, while the total marginal cost for the underwriting requirements is $344.35, pricing would need to reflect a cost of $430.44 in order to cover the marginal costs associated with underwriting policies that were Not Taken.

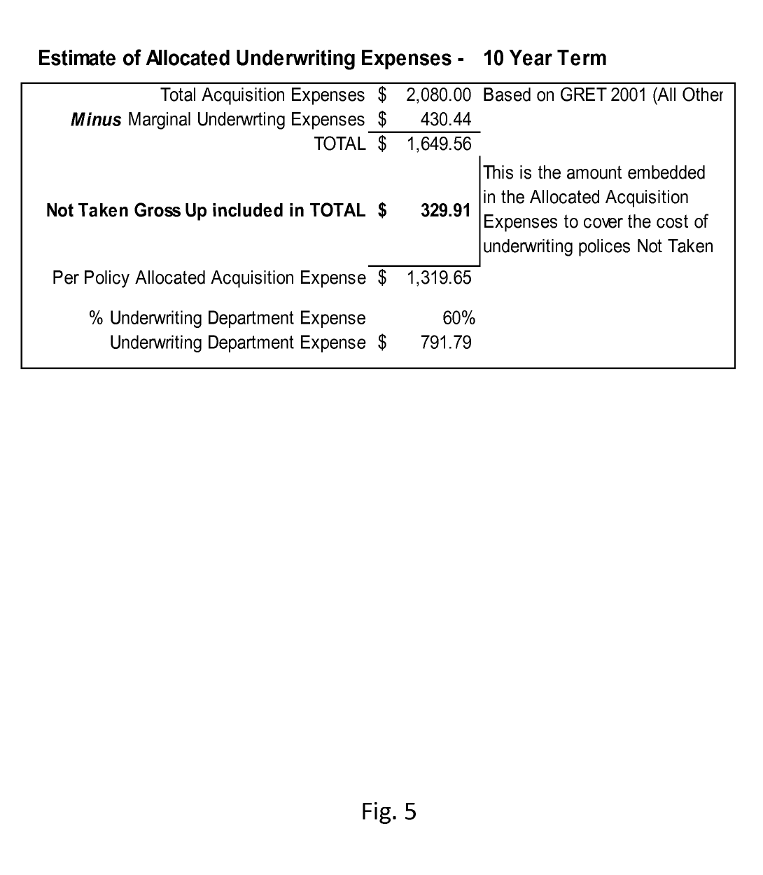

In addition to the marginal underwriting expenses associated with underwriting an insurance policy, there are also allocated underwriting expenses. That is, the allocated expenses relate to the fixed or overhead expenses the insurance company incurs in running an underwriting department. The allocated underwriting expenses are calculated as follows as shown in FIG. 5.
The marginal underwriting expenses ($430.44) are subtracted from the total acquisition expenses ($2,080.00) incurred in a normally underwritten insurance policy to determine the allocated underwriting expenses.
The result is multiplied by 20% to estimate the amount ($329.91) included as a gross up in allocated underwriting expenses to cover Not Taken insurance policies.
The gross up for Not Taken amount calculated above ($329.91) is subtracted to calculate a Per Policy Allocated Acquisition Expense ($1,319.65).
60% of the Per Policy Allocated Acquisition Expense ($1,319.65) or $791.79 in this example is assumed to be incurred by underwriters in the life company's Underwriting Department in order to review applicant risk profile data and create a risk assessment or underwriting decision. Depending on insurer, this percentage may be higher or lower.

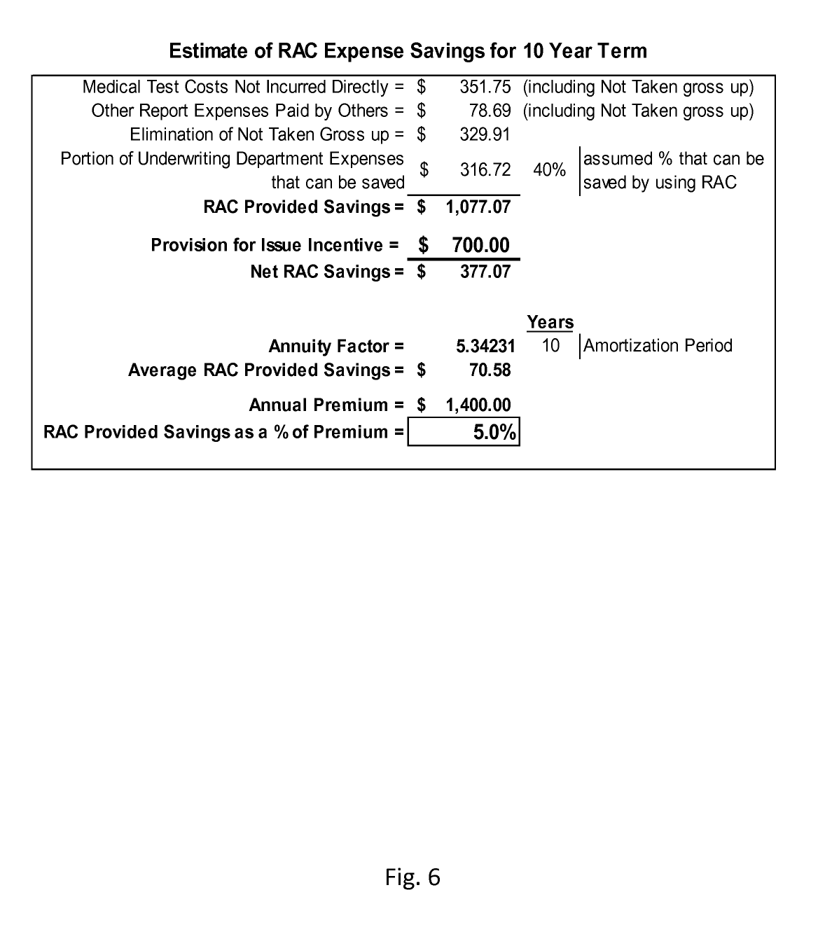

A policy issued using the RAC process could experience a reduction in direct underwriting costs as shown in FIG. 6.

It is assumed that the identified allocated Underwriting Department expense ($791.79) could be reduced by 40% through the use of the RAC for an expense savings of $316.72. This expense reduction would be driven by a the more efficient use of underwriting staff, less time required for underwriting, a reduction in underwriting staff, and a greater reliance on expert underwriting systems and could vary by insurance company.

As shown in the example above, the insurer could save acquisition costs totaling $1,077.07 for this 10 Year level premium Term policy.

In this example a $700 first year issue incentive provided by the insurer to defer the acquisition expenses “fronted” by the applicant could be provided and still reduce acquisition expenses by $377.07. In fact, the incentive the insurer could provide to applicants who actually purchase insurance from the company would, very likely, be well in excess of the costs actually incurred by the applicant.

The $377.07 net first year expense savings, when spread over the ten year term of the insurance policy, would allow the insurer to reduce its annual premium by, at least, $70.58 or 5% of the $1,400 annual premium.

Thus, in this example, a 10 Year Term policy issued using the RAC unbundled risk assessment process could provide a first year issue incentive equal to 50% of the premium in addition to reducing the annual premium by 5%.

### Whole Life Example

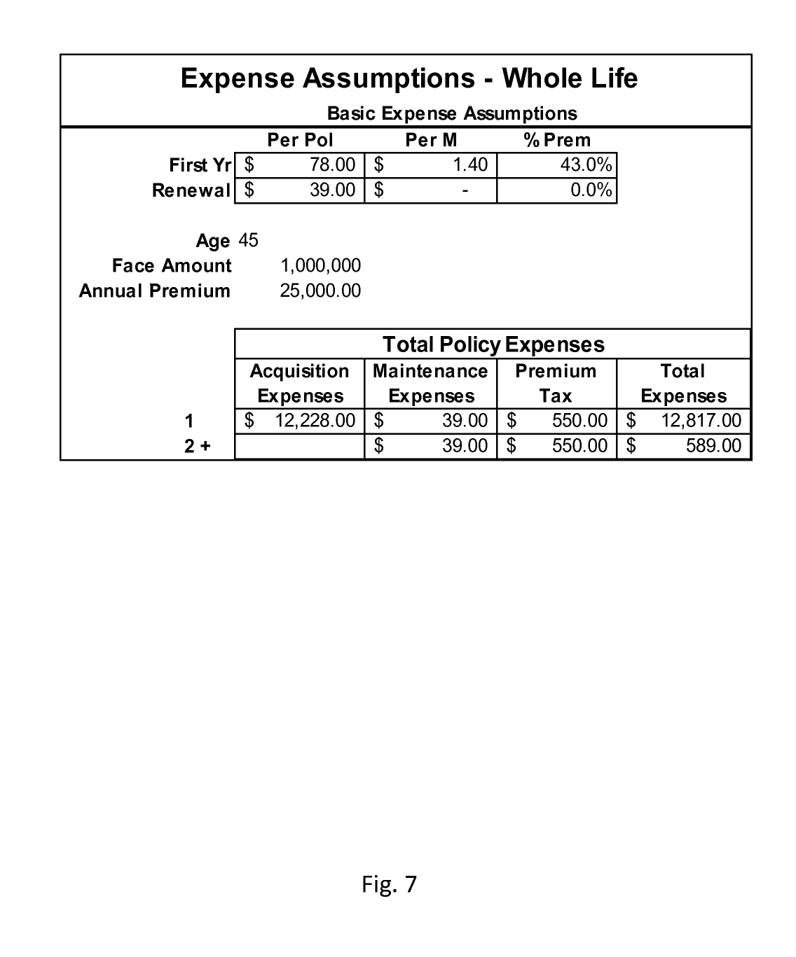

For a Whole Life policy, typical average expenses might be as shown in FIG. 7.

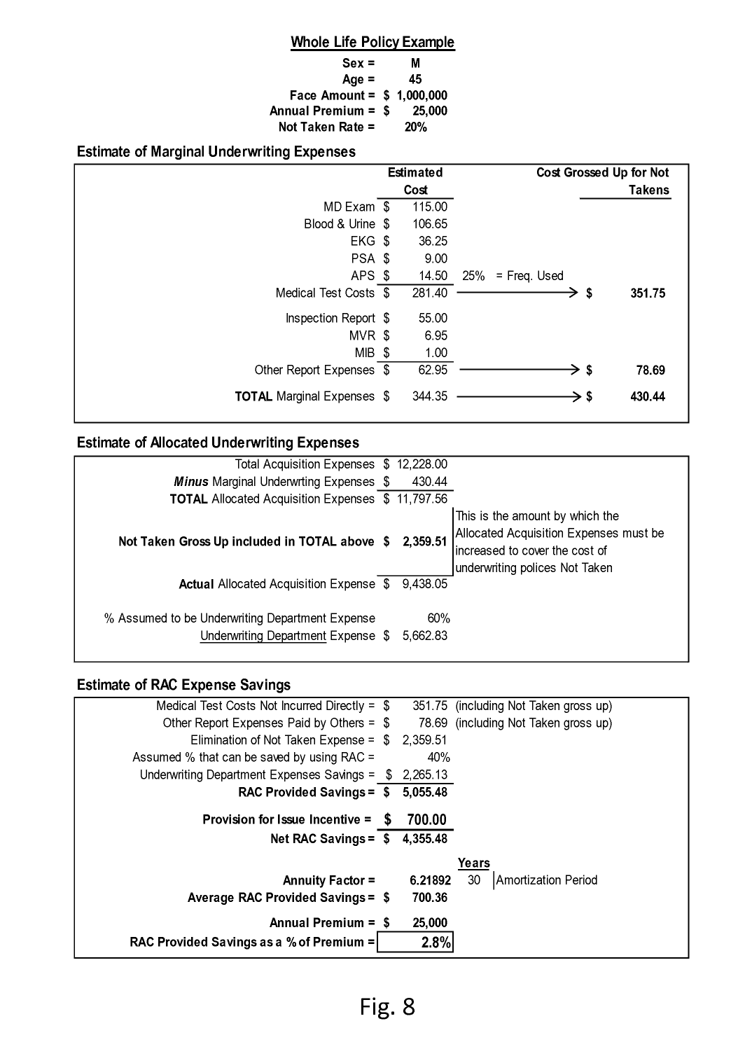

FIG. 8 shows the full development of the expense savings as a percent of premium for a typical WL policy issued to a Male Age 45 in the very best underwriting class.

For a Whole Life policy the use of the RAC unbundled risk assessment process would allow a 2.8% premium reduction and provide the $700 first year issue incentive.

### RAC Sources of Revenue

A Risk Assessment Company can provide services in multiple related areas, each one of which could be a source of revenue. The value of the RAC services would be derived from the overall expense reductions made possible by the elimination of redundancies that now exist in these related fields.

The RAC can develop revenue from services provided to each of the following:
Insurance companies which utilize the RAC process to underwrite insurance applications based on the Risk Profile Data Base (RPDB) maintained by the RAC.
Health care providers which utilize the RPDB and other RAC systems for maintaining patient electronic health records; electronic data interchange between physicians, hospitals, pharmacies, and health plans; and physician office management information systems.
Individual consumers who subscribe to the RAC for personalized life and health risk evaluations and access to personal health data and focused medical information provided via the Internet. An attempt would be made to provide these services to the individual RAC subscriber free of charge. Revenue from this source could be derived principally from the value the availability of this information service provided to the health care providers.
Employers and other organizations allowed authorized access to individual subscriber health information in lieu of physical exams they might otherwise require.
Research, business, or governmental organizations paying fees for access to anonymous, reliable health data for analysis, business planning, product development, research, or studies.

### The Consumer Benefits are Compelling

An RAC approach would create the following opportunities and advantages that would benefit the consumer with respect to the acquisition of life insurance:
The consumer would be a more attractive customer to an insurance carrier because:
   Their pre-approved risk class would be indicative of a serious interest in acquiring life insurance and foster competition among companies.
   There would be relatively little expense risk for the insurance carrier in providing an insurance quote or illustration.
   Coverage could be made effective immediately eliminating potential dissatisfaction with time service and administrative expense.
The consumer would have easily utilized flexibility in the selection of an insurer or insurers.
   That is, competitive, guaranteed quotes could be made available from many sources including the Internet.
   Large amounts of coverage could be diversified over a number of insurers with no additional selection processes or requirements.
The consumer would be able to put coverage into effect instantly as illustrated.
   The opportunity to effectively utilize the Web would be enabled.
   Paperless, signature-less policies could be issued with resulting issue and maintenance expense savings reflected in lower product pricing.
The consumer would receive benefit from the expense savings resulting from the elimination of redundancy in the use of medical facilities.
Independent Brokers would be better enabled to focus on and satisfy the financial needs of their client consumers.

### Additional Services Provided by the RAC

The RAC could provide a consumer with a report customized to his or her specific risk situation. It would be designed to provide that individual consumer with an accurate and independent assessment of the risks (life, health, and other) to which he or she was exposed and the extent of that exposure.

The RAC report could go further. In addition, and importantly, the report provided could indicate the discretionary changes the individual consumer could make in his or her life style that could have an impact on the risks or costs associated with those risks. The report could be designed to provide, in an easily understandable way, information pertinent to a complete understanding of the individual's risk scenario.

While initially envisioned as a life and health risk evaluator, the RAC, in order to completely satisfy the life insurance risk selection process, could additionally address financial elements associated with an individual. For example a financial evaluation would determine acceptable maximum amounts of coverage with respect to an individual life and establish insurable interest relationships. Or, for example, an RAC could provide individual subscribers with changes in the value of their in force life insurance policies as a result of changes in their health, mortality, or life expectancy which could allow them to better evaluate life settlement offers.

The RAC services could also be naturally extended into an evaluation of credit risk through use of credit history or “insurance” scoring techniques which are finding an application in property and casualty insurance underwriting. On the P&C side, there is a belief that a good credit history will be indicative of a good auto or home owner's risk. By adding this functionality to the services it provides, the RAC may find a roll in the P&C insurance industry as well. Credit history scores may have a similar application in life insurance underwriting. For example, good credit may be equivalent in some way to a generally healthy life style or to “truthfulness” in response to questions on an application.

Risks (or, costs) associated with extensive use of credit could be identified and less costly credit approaches might be recommended when the cost of credit is evaluated. For example, higher deductibles to lower auto insurance rates or other forms of consumer self insurance could be suggested (if appropriate) with the dollar savings utilized to, for example, save an “emergency fund”.

A participating consumer can be given access to a Web site in which information unnecessary for the basic evaluations provided could be input, anonymously, in order to get additional evaluations. Through such access, the consumer could play with “what if” scenarios to determine the impact on his or her life, health, financial, or credit scenario of discretionary changes they might make in their life style. For example, the effect of giving up smoking or losing weight on life and health expectancy and the costs associated with those changes with respect to potential health care or retirement costs could be evaluated. Or, the potential dollar savings associated with changing limits or deductibles for existing P&C coverages could be explored.

### CONCLUSION

While the disclosure has been described with reference to one or more different exemplary embodiments, it will be understood by those skilled in the art that various changes may be made and equivalents may be substituted for elements thereof without departing from the scope of the disclosure. In addition, many modifications may be made to adapt to a particular situation without departing from the essential scope or teachings thereof. Therefore, it is intended that the disclosure not be limited to the particular embodiment disclosed as the best mode contemplated for carrying out this disclosure.

1. A method wherein the life or health risk of a person is evaluated based on information maintained in a Risk Profile Data Base (RPDB) and the result of said evaluation is used for one or both of the following purposes:
to offer an insurance policy in an underwriting class determined by the said evaluation;
to provide said person with a life or health expectancy report containing suggestions on how said person can improve said life or health expectancy.

2. The method of claim 1 wherein an insurance company issues an insurance policy with premium discounts comprised of expense savings realized by said insurance company as a result of underwriting expense savings.

3. The method of claim 1 wherein a Risk Assessment Company (RAC) creates the Risk Profile Data Base (RPDB) by soliciting and accepting individual subscribers who maintain current health information in said RPDB and categorizes said individual subscribers as:
active if said individual subscribers routinely update their information in said RPDB by following standards prescribed by said RAC wherein said update might consist of, for example, completing a routine physical exam and posting such results to said RPDB;
inactive if said individual subscribers do not follow standards established by the RAC for updating information in said RPDB.

4. The method of claim 3 wherein an insurance company issues an insurance policy to active individual subscribers with premium discounts comprised of mortality savings realized by said insurance company as a result of improved mortality experienced by said active individual subscribers.
